(19) United States
(12) Patent Application Publication
(10) Pub. No.: US 2009/0164937 A1
(43) Pub. Date: Jun. 25, 2009

(54) Scroll Apparatus and Method for Manipulating Data on an Electronic Device Display

(76) Inventors: Alden Alviar, Indian Creek, IL (US); Tim Gassmere, Deerfield, IL (US); Tonya Luniak, Kildeer, IL (US)

Correspondence Address: PHILIP H. BURRUS, IV, 460 Grant Street, Atlanta, GA, 30312, US

(21) Appl. No.: 11/961,630

(22) Filed: Dec. 20, 2007

(51) Int. Cl. G06F 3/048

(52) U.S. Cl. 715/800; 715/863

(57) ABSTRACT

A method (700) and apparatus for adjusting the data presentation on the display (102) of an electronic device (100) is provided. A user touch scroll input device (101) is provided on the electronic device (100). A user then manipulates the user touch scroll input device (101) with a finger (116) or stylus to alter the presentation of data, which may include navigating a list of data elements (112) or altering the image magnification of an image (113) or the output of an on-board camera. Length of stroke, final point of user contact, direction of user motion, and an optional timer are all used to control the alteration of the data presentation. For example, a timing module (109) can initiate a timer with the user makes contact with the user touch scroll input device (101). While the timer is running, the data presentation is altered at a first rate. Once the timer expires, the data presentation is altered at a second rate.

### BACKGROUND

1. Technical Field

This invention relates generally to user input interfaces for electronic devices, and more specifically to a scroll-type control device having touch sensitive capabilities for controlling the presentation of data on a display.

2. Background Art

Portable electronic devices, such as mobile telephones, media devices, and personal digital assistants, are becoming more sophisticated. Designers are continually packing new and exciting features into these devices. By way of example, some portable electronic devices like phones and media players are capable of storing hundreds of music and video files. Similarly, the contents of an entire business card file can easily be stored as an address book list in many mobile telephones. Many mobile devices include cameras that can zoom in on, or out from, and image for the purpose of capturing pictures or video.

One problem associated with all of this data in a mobile device involves accessing the data or manipulating the presentation of data on the display. Most portable electronic devices today are small, handheld units. As such, the space on the device for displays and controls is limited. There is often only room for a few navigation keys. These keys generally take the form of a right, left, up, and down arrow. With large amounts of information to navigate, arrow keys can be slow and inefficient.

By way of example, it can be cumbersome to parse through a list of 500 songs by using an arrow key to advance the list one song at a time. Similarly, a person who has an electronic device with five possible camera magnification levels may miss a picture when individually sequencing through each zoom stage with an arrow key. The user may have to press the key again and again and again to find the right zoom level, thereby wasting time and missing a shot.

There is thus a need for an improved user interface for navigating through large amounts of data or for rapidly altering data presentations on the display of a portable electronic device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an electronic device having a partial-circle scroll wheel for altering the presentation of data on a display in accordance with embodiments of the invention.

FIG. 2 illustrates an exploded view of one type of user interface suitable for the scroll device and associated methods of embodiments of the invention.

FIG. 3 illustrates an exploded view of one electronic device suitable for use with the invention.

FIGS. 4 and 5 visually illustrate user interaction with a scroll device and the corresponding data presentation alteration associated with embodiments of the invention.

FIGS. 6 and 7 illustrate methods of altering the presentation of data on an electronic device in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to altering the presentation of data, or an image magnification level, presented on a display of an electronic device to a user. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of manipulating the presentation of data on an electronic device as described herein. The non-processor circuits may include, but are not limited to, an image capture device, database modules, signal drivers, clock circuits, and power source circuits. As such, these functions may be interpreted as steps of a method to perform data manipulation on the display of an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a touch sensitive scroll device that is integrated with a user interface. Some embodiments of the invention, including the “full zoom” or “end of list” manipulation, as described below, employ a non-continuous scroll device. The scroll device is “non-continuous” in that it has a first end and a second end, rather than being a continuous circle. In one embodiment, a touch sensor uses these ends in determining what data presentation should appear on the display. Other embodiments of the invention, including the ability to control scroll speed, are suitable for both continuous scroll device and a non-continuous scroll devices.

Embodiments of the invention provide a user with a convenient and simple way of adjusting the presentation of data on a display. For instance, using the scroll device and associated methods of the invention, a user may adjust the image magnification of an embedded camera. Alternatively, the user may adjust the magnification associated with an image stored in memory. Further, the user may adjust the portion of a list of data that is presented on the display.

Using image magnification as an example, embodiments of the invention provide a touch-sensitive scroll device that is capable of rapidly and accurately adjusting the amount of “zoom” or image magnification. For instance, in one embodiment, a mobile telephone is equipped with a digital camera having and adjustable magnification feature. In one example, a user can adjust the magnification level between a 1× level, a 2× level, a 4× level, an 8× level, and so forth. Rather than using arrow keys, or plus and minus keys, to adjust this level of magnification one step at a time, the user employs a scroll device—which can be non-continuous or partially circular in shape—to quickly and accurately adjust to the desired level of magnification.

In one embodiment, the user makes a time-dependent, continuous, stroke along the scroll device. This stroke may be either clockwise or counterclockwise, depending upon whether an increase or decrease in image magnification is desired. The user's initial contact with the scroll device determines the beginning of the stroke. The initial contact location may be at any point along the scroll device. A controller then monitors the position, velocity, length of stroke, or combinations thereof to adjust the image magnification. When the user removes their finger or stylus from the scroll device, the controller detects the release point.

In using such a system, different modes of zoom operation can be achieved. In one embodiment, a timer is started when the user makes contact with the scroll device. While the user is moving his finger or stylus along the device and the timer is running, the magnification change occurs rapidly. Once the timer expires, the rate of change steps to a slower level. As such, the user can initially make a macro adjustment, with micro adjustments occurring when the timer has expired. Length of stroke and end of stroke location can be considered in conjunction with time, thereby providing non-incremental adjustments.

In another embodiment, the scroll device is mapped into separate physical zones. In addition to the fast/slow manipulation associated with the timer, contact with any one zone can be detected to determine which level of image magnification the user desires. As predetermined zones are traversed along the scroll device during the user's motion, the image magnification step associated with that zone is updated accordingly.

In another embodiment, where the scroll device is non-continuous, a predetermined area near the end of the non-continuous scroll device is used to detect a maximum or minimum zoom level. Such an embodiment enables a user to quickly jump to the maximum or minimum image magnification level from any other level my sweeping a finger or stylus from some point on the scroll device to the end of the scroll device. This maximum or minimum jump occurs regardless of the state of the timer, where the timer is used.

Embodiments of the invention enable a user to quickly converge on a desired magnification level from a previous level. Alternatively, where the data presentation is a list of songs or addresses, embodiments of the invention facilitate quick convergence on a particular record. When using the timer, if the user maintains contact with the scroll device after expiration of the timer, a fast change in the data manipulation rate converts to a slow data manipulation rate. The slower rate allows the user employ smaller changes in data presentation for finer control.

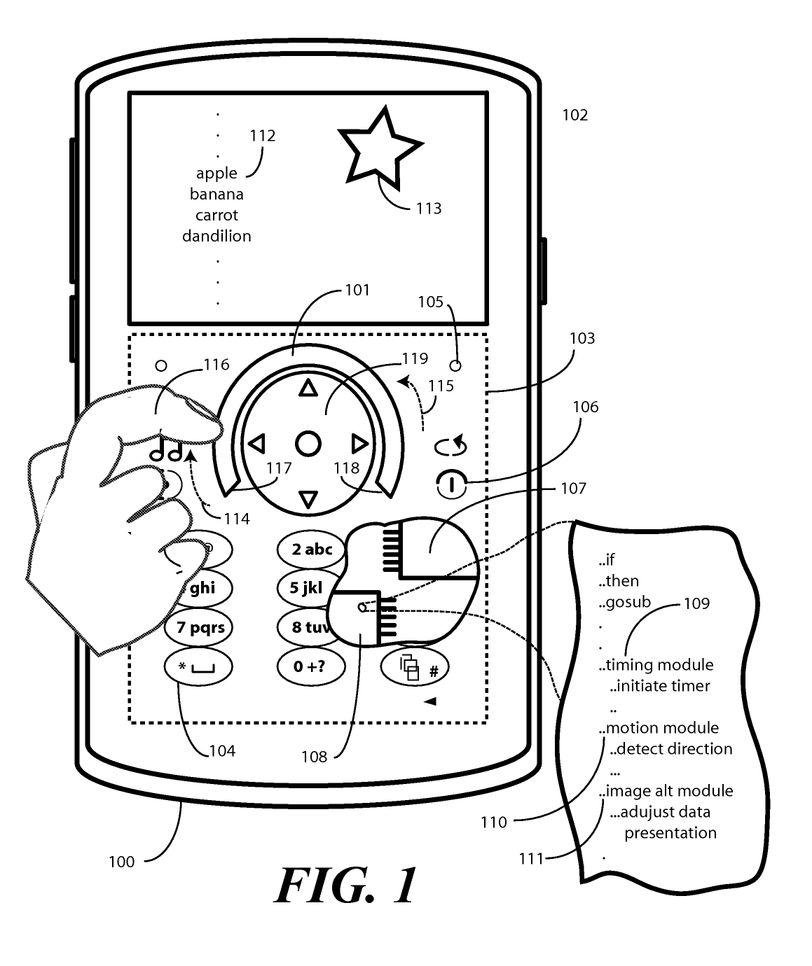

Turning now to FIG. 1, illustrated therein is an electronic device 100 having a user touch scroll input device 101 for altering the presentation of data 112 or an image 113 on the display 102 in accordance with embodiments of the invention. The user touch scroll input device 101 works as a device navigation control mechanism, and is one element of a user interface 103. The user interface 103 may further include a keypad 104, soft keys 105, or device specific keys 106. For illustrative purposes, the electronic device 100 of FIG. 1 is a mobile telephone. It will be obvious to those of ordinary skill in the art having the benefit of this disclosure that the invention is not so limited. Other electronic devices, including gaming devices, multimedia players, personal digital assistants, portable computers, and the like could also use the user touch scroll input device 101 and associated methods described herein. Note also that the other components of the user interface 103 are not mandatory—it is possible to have an electronic device that uses only the user touch scroll input device 106 as a control mechanism.

The electronic device 100 also includes a display 102 for presenting data 112 or an image 113 to a user. The data 112 or image 113 may be any of the following: lists of data elements; images stored in memory; video stored in memory; an output of an on-board camera; and so forth. This list is not exclusive, as other types of data may be presented as well. Examples of data 112 include lists of elements, such as addresses, telephone numbers, songs, videos, etc., that are too numerous to be presented on the display 102 at one time. Examples of images 113 include one image magnification level of a camera output, which a user may wish to change to another image magnification level.

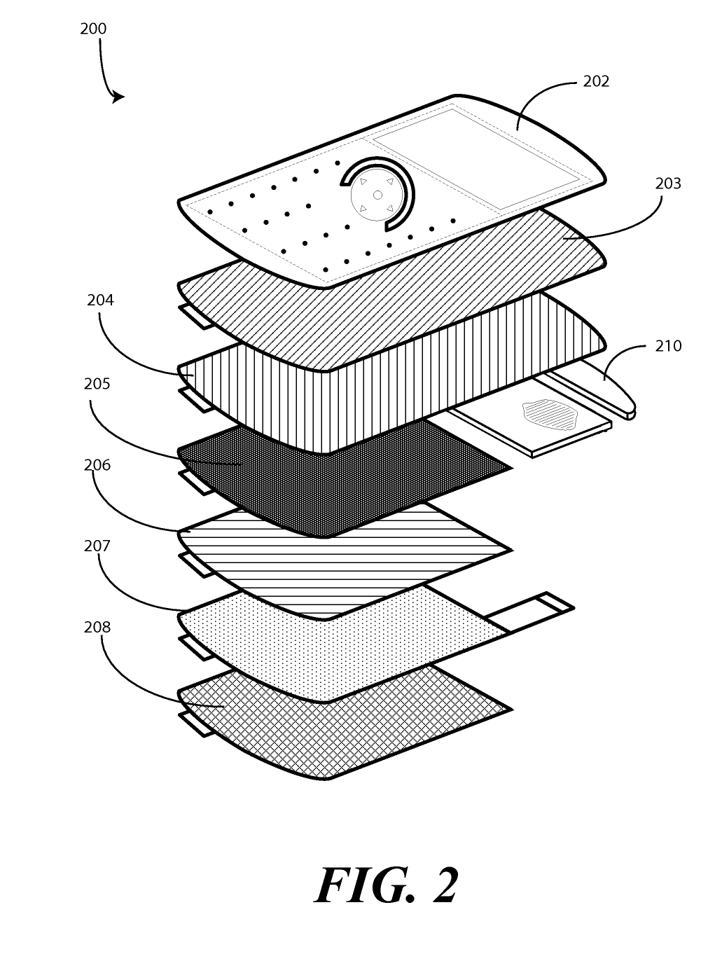

A processor 107, which may be a microcontroller, a microprocessor, ASIC, logic chip, or other device, serves as the brain of the electronic device 100. By executing operable code stored in an associated memory device 108, the processor 107 performs the various functions of the device. In one embodiment, the processor 107 is coupled to the user touch scroll input device 101 and is configured with operable code to detect user contact with the user touch scroll input device 101 by way of a capacitive sensor layer (which is discussed in FIG. 2).

The processor 107 executes various modules, which in one embodiment comprise executable software stored in the memory device 108, to perform various tasks associated with altering the image or data presented on the display 102. In one embodiment, these modules include a timing module 109, a motion detection module 110 and an image alteration module 111.

The timing module 109, which is operable with the processor 107, is configured to initiate a timer when the processor 107—working with a capacitive sensor layer or other detection device—detects user contact with the user touch scroll input device 101. As noted above, and as will be explained in more detail below, the timer can be used to transition from a rapid scroll rate to a slow scroll rate. Thus, when a user touches the user touch scroll input device 101 with a finger 116 or stylus, in one embodiment the timing module 109 initiates a timer that is set to run for a predetermined period, such as one to three seconds.

The motion detection module 110, which is also operable with the processor 107, is configured to determine a direction of user motion. The motion detection module 110 samples successive positions of the user's finger 116 or stylus along the user touch scroll input device 101 to determine which direction the user's finger 116 or stylus is moving. In the exemplary embodiment of FIG. 1, the user touch scroll input device 101 is illustrated as a curved, non-continuous, partially circular wheel. Thus the user's motion may be in a clockwise direction 114 or in a counterclockwise direction 115. Where the user touch scroll input device 101 is a straight strip, the user's motion may be either right or left, or up or down, depending upon the orientation of the user touch scroll input device 101.

The image alteration module 111 is configured to alter the presentation of the data 112 or image 113 on the display 102 in response to the user's motion, position, and/or time spent touching the user touch scroll input device 101. For example, where the data presentation on the display 102 is an image 113, such as the output from an on-board camera, the image alteration module 111 can be configured to alter an image magnification level, thereby causing the on-board camera to zoom in and out. The timer associated with the timing module 109 may further be used to provide a more refined data alteration capability. By way of example, the image alteration module 111 can be configured to alter the magnification of the image 113 at a first rate—corresponding to the direction of the user motion—while the timer is running. This first rate may be a “fast step zoom” wherein small movements of the user's finger 116 or stylus cause large jumps in zoom magnification. When the timer expires, the image alteration module 111 may be configured to alter the magnification of the image at a second rate, which also would correspond to the direction of user motion. This second rate may be a “slow step zoom” wherein movements of the user's finger 116 or stylus cause small jumps in zoom magnification.

Where the data presentation is a list, such as a list of songs or addresses, the image alteration module 111 can be configured to scroll through the list much in the same way that it adjusted zoom in the preceding paragraph. Again by way of example, the image alteration module 111 can be configured to alter the portion of data 112 presented on the display 102 at a first rate—corresponding to the direction of the user motion—while the timer is running. This first rate may be a “fast scroll” wherein small movements of the user's finger 116 or stylus cause large jumps along the list of data 112. When the timer expires, the image alteration module 111 can be configured to alter the portion of data 112 presented on the display 102 at a second rate, which also would correspond to the direction of user motion. This second rate may be a “slow scroll” wherein movements of the user's finger 116 or stylus cause small jumps along the list of data 112.

In the exemplary embodiment of FIG. 1, the user touch scroll input device 101 is a non-continuous, curved surface. The user touch scroll input device 101 of FIG. 1 resembles an upside-down horseshoe. While the user touch scroll input device 101 need not be either non-continuous or curved in shape, the non-continuous structure does offer advantages in certain applications. The non-continuous configuration can be used by the image alteration module 111, in conjunction with the motion direction module 109, to facilitate rapid scrolling to a maximum or minimum change in the data presentation on the display 102.

To illustrate by example, where the user touch scroll input device 101 is non-continuous, it includes a first end 117 and a second end 118. When the processor 107 detects the user contact at either the first end 117 or the second end 118, the image alteration module 111 can be configured to automatically cause the data presentation to jump to a limit, such as a maximum or minimum point. Where the data presentation is that of an image 113 with a particular magnification, the image alteration module 111 can be configured to alter the magnification of the image 113 to either a maximum magnification or a minimum magnification. Similarly, where the data presentation is that of a list of data 112, the image alteration module 111 can be configured to alter the portion of data presented to the top of the list or the bottom of the list, wherein the list is arranged in accordance with a predetermined key (such as by alphabetizing).

Next, the motion detection module 110 can be configured to use the user's direction of motion in altering the data presentation. For instance, where the direction of user motion is the clockwise direction 114, the image alteration module 111 can be configured to scroll the data 112 or image 113 in a first direction. Where the direction of user motion is the counterclockwise direction 115, the image alteration module 111 can be configured to scroll the data 112 or image 113 in a second direction. Illustrating by example, where the data presentation is the output of an on-board camera, when the direction of user motion is in the clockwise direction 114, the image alteration module 111 can be configured to increase the magnification of the image 113. Where the direction of user motion is in the counterclockwise direction 115, the image alteration module 111 can be configured to decrease the magnification of the image 113.

Where the user touch scroll input device 101 is used to alter the data presentation on the display 102, the processor 107 monitors the contact of the user's finger 116 or stylus with the user touch scroll input device 101. Where this contact terminates, all timers or modules reset and wait for another point of user contact. Thus, in the above examples, the image alteration module 111 can be configured to alter the magnification of the image 113 or data 112 for as long as the processor 107 determines that the user is in contact with the user touch scroll input device 101. Where contact has terminated, the alteration of the data presentation can cease and the timers can reset.

In one embodiment, the processor 107 monitors how far the user's finger 116 or stylus moves along the user touch scroll input device 101. The amount of alteration of the data presentation, in one embodiment, is proportional to the distance the user's finger 116 or stylus moves along the user touch scroll input device 101. For example, the image alteration module 111 can be configured to alter the magnification of the image 113, or the portion of data 112 displayed, by an amount that is proportional with the distance of the motion along the user touch scroll input device 101.

In the exemplary embodiment of FIG. 1, in addition to the user touch scroll input device 101, a navigation device 119 comprising a plurality of arrows is included. This navigation device 119 is optional and may be included to make incremental step adjustments to the data presentation. However, the navigation device 119 is not necessary in embodiments where the timer is employed, as movements by the user upon expiration of the timer can also be configured to make incremental step adjustments to the data presentation. However, where space allows, the optional navigation device 119 may be included.

Turning now to FIG. 2, illustrated therein is an exploded view of one embodiment of a user interface 200 for an electronic device (100) in accordance with the invention. The exemplary user interface 200 shown in FIG. 2 is that a “morphing” user interface, in that it is configured to dynamically present one of a plurality of mode-based sets of user actuation targets to a user. The morphing user interface 200, which includes the user touch scroll input device 101, is well suited for embodiments of the invention because this user interface 200 is a “touch sensitive” user interface. It is touch sensitive in that a capacitive sensor layer 203 detects the presence of a user's finger or stylus. As this capacitive sensor layer 203 is already a component of the user interface 200, the same capacitive sensor layer 203 may be used as a touch sensor for the user touch scroll input device 101. Such a user interface 200 is described in greater detail in copending, commonly assigned U.S. application Ser. No. 11/684,454, entitled “Multimodal Adaptive User Interface for a Portable Electronic Device,” which is incorporated herein by reference.

This user interface 200 is illustrative only, in that it will be obvious to those of ordinary skill in the art having the benefit of this disclosure that any number of various user interfaces could be substituted and used in conjunction with the user touch scroll input device 101 and associated data presentation alteration method described herein. For instance, a more traditional user interface, such as one that includes popple-style buttons, could be used with the user touch scroll input device 101 of the present invention. Alternatively, a user interface having only a user touch scroll input device 101 may be used in accordance with embodiments of the invention.

Starting with the top layer of this exemplary user interface 200, a cover layer 202 serves as a protective surface. The user interface 200 may further include other elements or layers, such as the capacitive sensor layer 203, a segmented electroluminescent device 205, a resistive switch layer 206, a substrate layer 207, filler materials 210 and a tactile feedback layer 208.

The cover layer 202, in one embodiment, is a thin film sheet that serves as a unitary fascia member for the user interface 200. Suitable materials for manufacturing the cover layer 202 include clear or translucent plastic film, such as 0.4 millimeter, clear polycarbonate film. In another embodiment, the cover layer 202 is manufactured from a thin sheet of reinforced glass. The cover layer 202 may include printing or graphics.

The capacitive sensor layer 203 is disposed below the cover layer 202. The capacitive sensor layer 203, which is formed by depositing small capacitive plate electrodes on a substrate, is configured to detect the presence of an object, such as a user's finger (116), near to or touching the user interface 200 or the user touch scroll input device 101. Control circuitry (such as processor 107) detects a change in the capacitance of a particular plate combination on the capacitive sensor layer 203. The capacitive sensor layer 203 may be used in a general mode, for instance to detect the general proximate position of an object. Alternatively, the capacitive sensor layer 203 may also be used in a specific mode, such as with the user touch scroll input device 101, where a particular capacitor plate pair may be detected to detect the location of an object along length and width of the user interface 200 or the user touch scroll input device 101.

A segmented optical shutter 204 then follows. The segmented optical shutter 204, which in one embodiment is a twisted nematic liquid crystal display, is used for presenting one of a plurality of keypad configurations to a user by selectively opening or closing windows or segments. Electric fields are applied to the segmented optical shutter 204, thereby changing the optical properties of the segments of the optical shutter to hide and reveal various user actuation targets. Additionally, a high-resolution display can be hidden from the user when the device is OFF, yet revealed when the device is ON. The application of the electric field causes the polarity of light passing through the optical shutter to rotate, thereby opening or closing segments or windows.

A segmented electroluminescent device 205 includes segments that operate as individually controllable light elements. These segments of the segmented electroluminescent device 205 may be included to provide a backlighting function. In one embodiment, the segmented electroluminescent device 205 includes a layer of backlight material sandwiched between a transparent substrate bearing transparent electrodes on the top and bottom.

The resistive switch layer 206 serves as a force switch array configured to detect contact with any of one of the shutters dynamic keypad region or any of the plurality of actuation targets. When contact is made with the user interface 200, impedance changes of any of the switches may be detected. The array of switches may be any of resistance sensing switches, membrane switches, force-sensing switches such as piezoelectric switches, or other equivalent types of technology.

A substrate layer 207 can be provided to carry the various control circuits and drivers for the layers of the display. The substrate layer 207, which may be either a rigid layer such as FR4 printed wiring board or a flexible layer such as copper traces printed on a flexible material such as Kapton®, can include electrical components, integrated circuits, processors, and associated circuitry to control the operation of the display.

To provide tactile feedback, an optional tactile feedback layer 208 may be included. The tactile feedback layer 208 may include a transducer configured to provide a sensory feedback when a switch on the resistive switch layer detects actuation of a key. In one embodiment, the transducer is a piezoelectric transducer configured to apply a mechanical “pop” to the user interface 200 that is strong enough to be detected by the user.

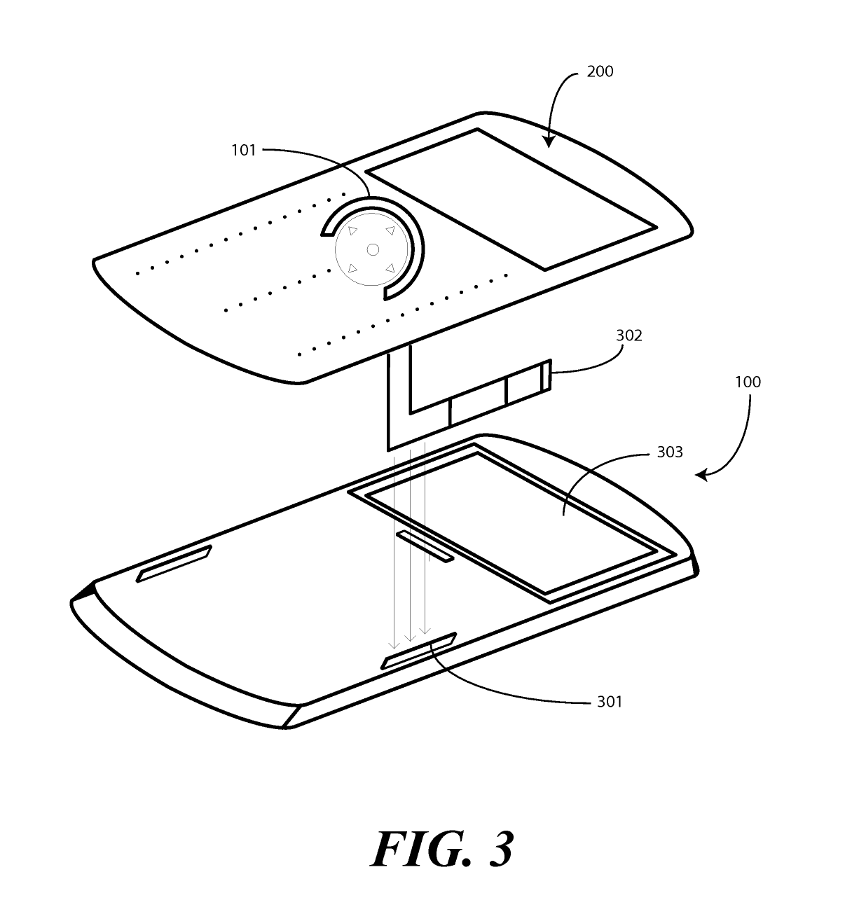

Turning now to FIG. 3, illustrated therein is the user interface 200—having the user touch scroll input device 101—being coupled to an electronic device body 301 to form the electronic device 100. In this exemplary embodiment, a connector 302 fits within a connector receptacle 303 of the electronic device body 301, thereby permitting an electrical connection between the user interface 200 and the other components and circuits of the portable electronic device 100.

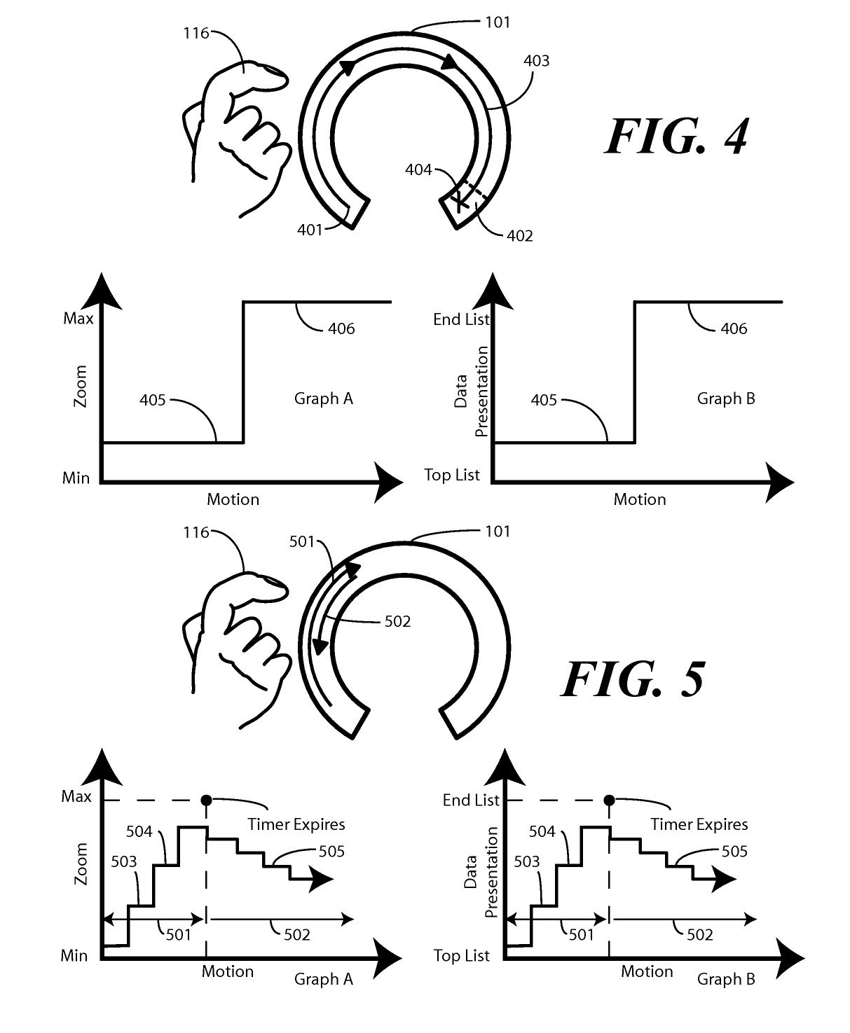

Turning now to FIGS. 4-5, illustrated therein are graphical representations of various data presentation alteration methods using a user touch scroll input device 101 in accordance with embodiments of the invention. In each of FIGS. 4 and 5, graph A is representative of the alteration of an image magnification, be it one stored in memory, presented on a display, or that is the output of an on-board image capture device. Graph B is representative of the alteration of a list of data, be it a list of songs, addresses, applications, files, or other list.

Beginning with FIG. 4, illustrated therein is a method of data presentation alteration as determined by the user's physical motion along the user touch scroll input device 101. The method of FIG. 4 involves a full stroke in a clockwise motion. It will be clear to those of ordinary skill in the art having the benefit of this disclosure that a counterclockwise motion may be used as well. Further, reverse logic may be employed thereby causing the data presentation alteration to be taken to either end of the alteration limit spectrum. Note also that the user motion need not be a full stroke, as will be described in the paragraphs below. To simplify the discussion, the exemplary data presentation alteration used with respect to FIGS. 4-5 will be that of zoom or image magnification level. Other data presentation alteration schemes, including navigating lists of data elements, work in substantially the same manner.

As noted above, a processor (107) detects an initial contact position 401 of a user's finger (the user's digit) or stylus along the user touch scroll input device 101, which in FIG. 4 is illustrated as a non-continuous, curved scroll wheel. The motion detection module (110) then detects a direction of user motion 403 of the user's finger 116 or stylus along the user touch scroll input device 101. The processor (107) then detects a final contact position of the user's finger 116 or stylus.

In one embodiment, the image alteration module (111) determines that the image magnification is to be taken to the maximum limit based upon the direction of user motion 403 and the length of stroke. Since the length of stroke is substantially across the entirety of the user touch scroll input device 101, the image alteration module (111) transitions the data presentation from an initial magnification level 405 to a maximum magnification level 406. In the illustrative embodiment of FIG. 4, since the direction of user motion 403 is clockwise, the maximum magnification level 406 is maximum zoom. However, the reverse logic may be used.

In another embodiment, rather than using the length of stroke, the image alteration module (111) uses initial contact position 401 and final contact position 404 of the user's finger 116 or stylus. In such an embodiment, the non-continuous structure of the user touch scroll input device 101 is used. The user touch scroll input device 101 is divided into sections, with a predetermined range 402 being established about the ends of the user touch scroll input device 101. Where the initial contact position 401 is outside this predetermined range 402, and the final contact position 404 is within the predetermined range, the data presentation is advanced to an end limit that corresponds with the direction of movement. Thus, a user may touch the user touch scroll input device 101 in the middle and slide his finger 116 clockwise to the end of the user touch scroll input device 101 to achieve maximum zoom. Correspondingly, the user may touch the user touch scroll input device 101 in the middle and slide his finger 116 counterclockwise to the end of the user touch scroll input device 101 to achieve minimum image zoom. Of course, reverse logic could also be employed. Where the data presentation alteration is manipulation of a list of data elements, organized in accordance with a predetermined organizational key such as alphabetization, the user may slide his finger 116 to the ends of the user touch scroll input device 101 to scroll to the list end or list beginning. This mode of operation permits the user to fully zoom in or out in—or move to the beginning or end of a list—with a single manipulation of the user touch scroll input device 101.

In another embodiment, as noted above, the timing module (109) and a timer may be used to adjust the data presentation alteration rate. In such an embodiment, when the processor (107) detects the initial contact position 401 of the user's finger 116 or stylus, the timing module (109) initiates a timer. While the timer is running, movement of the user's finger 116 or stylus causes step jumps, such as the jump from zoom level 405 to zoom level 406, at a first rate. When the timer expires, however, movement of the user's finger 116 or stylus causes incremental changes in data presentation at a second rate. In one embodiment the second rate is slower than the first rate, thereby allowing the user to initially make macro adjustments, and to make more refined adjustments by maintaining contact with the user touch scroll input device 101 until after the timer expires.

Turning now to FIG. 5, illustrated therein is the user touch scroll input device 101 and corresponding user motion across the user touch scroll input device 101 both before the timer has expired (stroke 501) and after the timer has expired (stroke 502). Before the timer expires, movements of the user's finger 116 causes large changes in zoom, as shown at steps 503,504. Once the timer expires however, the motion detection module (110) detects a second direction of motion 502 of the user's finger 116 or stylus. The second direction of motion 502 may be in the same direction as the first direction 501 of user motion (403). The second direction of motion 502 may be due to a single stroke that begins before the timer expires and ends after the timer expires. Alternatively, the second direction of motion 502 may be a motion opposite the first direction of user motion 501.

Since the timer is expired, the image alteration module (111) incrementally alters the data presentation—which in one embodiment occurs at a slower, more step-wise rate—in accordance with the second direction of motion. The incremental steps are illustrated by zoom level 505.

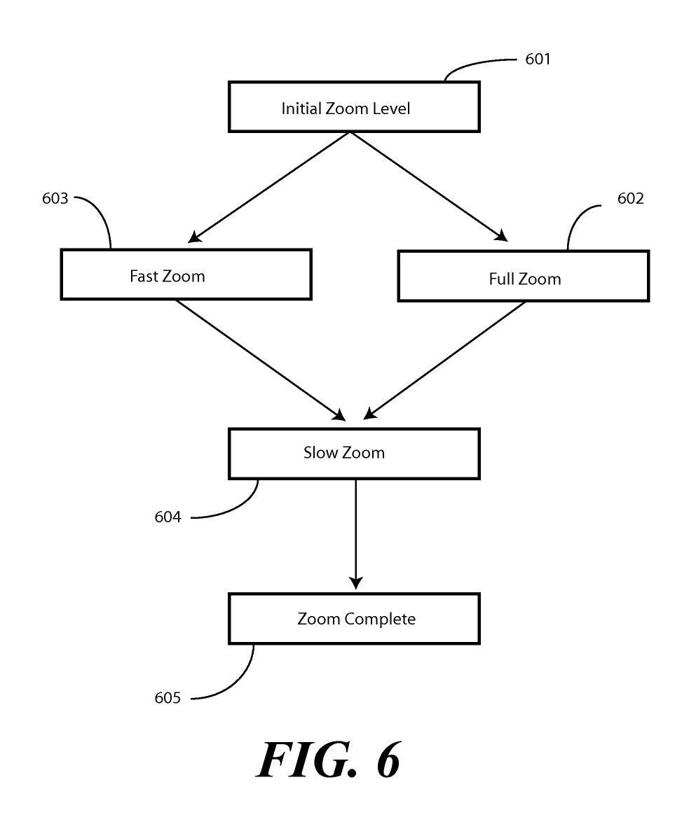

A composite flow chart of some of these embodiments is illustrated in FIG. 6. Turning now to FIG. 6, the initial zoom level—or scroll position where the data is a list—is detected at step 601. The user may then—by either stroke length, initial contact point/final contact point, or combinations thereof—take the zoom level to an end limit at step 602. Alternatively, the user may—by way of the timer and timing module (109)—adjust the data presentation at a first rate at step 603.

Where the timer is employed, the timer is initiated when the processor (107) detects the user contact with the scroll device. At step 603, the data presentation is altered at a first alteration rate in a direction corresponding with the detected user direction of motion while the timer is running. Upon expiration of the timer, the data presentation is altered at a second alteration rate in a direction corresponding with the user direction of motion at step 604. At step 605, the user achieves the desired data presentation.

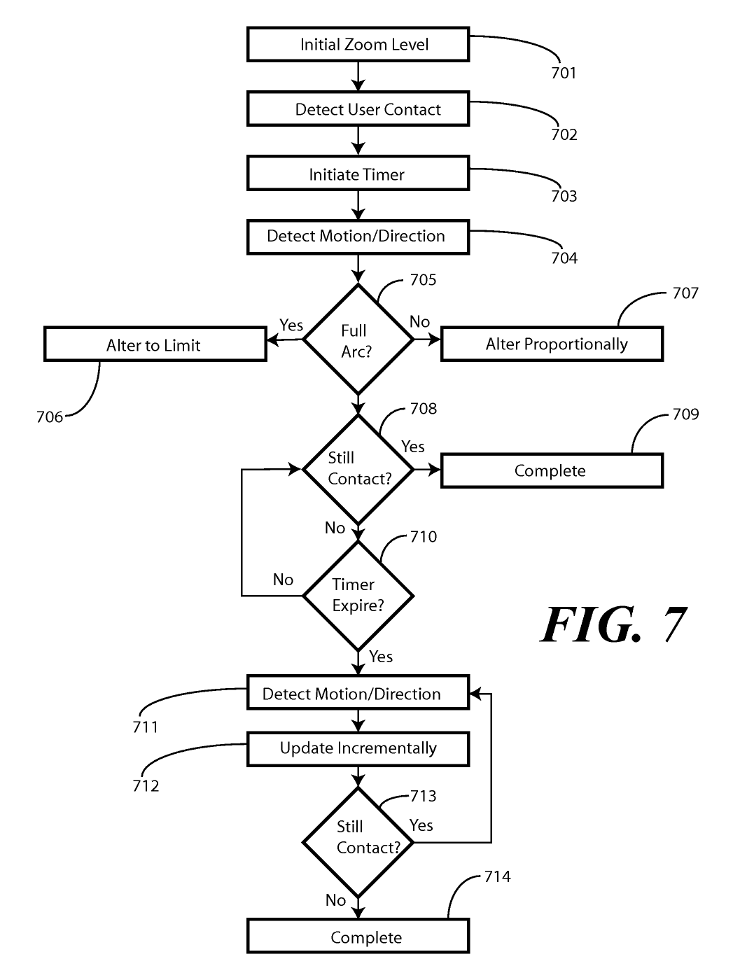

Turning now to FIG. 7, illustrated therein is a more detailed method 700 of adjusting the data presentation on the display (102) of an electronic device (100) when using a timer in accordance with embodiments of the invention. Beginning at step 701, the initial data presentation level is detected. At step 702, a processor (107) or other device detects user contact with the scroll device, which may be a non-continuous scroll device like the partial circle shown in FIGS. 4-5. At step 703, the timer is initiated.

At step 704, the motion detection module (110) detects the user's direction of motion along the scroll device from the point of initial contact. Where the length of stroke input is employed, a detection of whether the user's motion is across the entire scroll device is made at decision 705. Where the user motion is a full motion, the data presentation is altered to an end limit, such as minimum or maximum zoom, at step 706. Where either length of stroke is not employed as an alteration input, or where a full arc motion is not detected, the data presentation is altered at a first alteration rate in a direction corresponding with the user's direction of motion at step 707.

The processor (107) continually checks to see whether the user remains in contact with the scroll device, as is illustrated by decision 708. Where the user releases the scroll device prior to expiration of the timer, the data presentation alteration process is complete (step 709). Where the user maintains contact with the scroll device until the timer expires however, determined at decision 710, the data presentation alteration rate is changed to a second alteration rate. User direction is continually monitored (step 711). Since the timer has expired, the data presentation is altered at the second alteration rate in the direction corresponding with the user's direction of motion at step 712. Once the user then releases the scroll device (decision 713), the data presentation alteration process completes at step 714.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for altering a data presentation on a display of an electronic device having a non-continuous scroll wheel, the method comprising the steps of:
detecting an initial contact position of a user's digit or stylus along the non-continuous scroll wheel;
detecting a direction of movement of the user's digit or stylus along the non-continuous scroll wheel; and
detecting a final contact position of the user's digit or stylus along the non-continuous scroll wheel;
wherein when the final contact position is within a predetermined range of an end of the non-continuous scroll wheel, advancing the data presentation to an end limit corresponding to the direction of movement.

2. The method of claim 1, wherein the data presentation comprises an image, further wherein the end limit comprises one of a maximum image zoom or a minimum image zoom.

3. The method of claim 2, wherein the non-continuous scroll wheel comprises an incomplete circle, wherein the direction of movement comprises a clockwise movement, wherein the end limit comprises the maximum image zoom.

4. The method of claim 2, wherein the non-continuous scroll wheel comprises an incomplete circle, wherein the direction of movement comprises a counterclockwise movement, wherein the end limit comprises the minimum image zoom.

5. The method of claim 1, wherein the data presentation comprises a list, further wherein the end limit comprises one of a list end or a list beginning, wherein the list is arranged in accordance with a predetermined organizational key.

6. The method of claim 1, further comprising the steps of:
initiating a timer upon detecting the initial contact position of the user's digit or stylus;
detecting expiration of the timer while the user's digit or stylus is still in contact with the non-continuous scroll wheel;
detecting a second direction of movement of the user's digit or stylus; and
incrementally altering the data presentation in accordance with the second direction of movement of the user's digit or stylus.

7. A method of adjusting a data presentation on a display of an electronic device having an scroll device, the method comprising the steps of:
detecting a user contact with the scroll device;
initiating a timer;
detecting a user direction of motion along the scroll device from the user contact;
altering the data presentation at a first alteration rate in a direction corresponding with the user direction of motion prior to expiration of the timer; and
upon expiration of the timer, altering the data presentation at a second alteration rate in the direction corresponding with the user direction of motion.

8. The method of claim 7, wherein the data presentation comprises an image presented on the display.

9. The method of claim 8, wherein the step of altering the data presentation comprises changing an image magnification of one of the image presented on the display or an output of an image capture device of the electronic device.

10. The method of claim 9, wherein the first alteration rate is faster than the second alteration rate.

11. The method of claim 9, wherein the scroll device defines a partial-circle, wherein the user direction of motion comprises one of a clockwise motion of a user digit along the scroll device or a counterclockwise motion of the user digit along the scroll device.

12. The method of claim 11, wherein the direction comprises one of an increasing image magnification or a decreasing image magnification.

13. A electronic device for presenting and altering an image to a user, comprising:
a user touch scroll input device;
a processor coupled to the user touch scroll input device and configured to detect user contact and a user motion with the user touch scroll input device;
a display coupled to the processor configured to present the image; and
an image presentation module, operable with the processor, comprising:
a timing module configured to initiate a timer upon the processor detecting the user contact;
a motion direction module configured to determine a direction of the user motion; and
an image alteration module configured to alter a magnification of the image at a first rate, corresponding to the direction of the user motion, while the timer is running, and to alter the magnification of the image at a second rate, corresponding to the direction of the user motion, when the timer expires.

14. The electronic device of claim 13, wherein the user touch scroll input device comprises a non-continuous, curved surface having a first end and a second end, wherein when the processor detects the user contact at one of the first end or the second end, the image alteration module is configured to alter the magnification of the image to one of a maximum magnification or a minimum magnification.

15. The electronic device of claim 13, wherein when the direction of the user motion comprises a clockwise motion, the image alteration module is configured to increase the magnification of the image, further wherein when the direction of the user motion comprises a counterclockwise motion, the image alteration module is configured to decrease the magnification of the image.

16. The electronic device of claim 13, wherein the image alteration module is configured to alter the magnification of the image until the processor determines that the user contact has terminated.

17. The electronic device of claim 16, wherein the timing module is configured to reset when the user contact has terminated.

18. The electronic device of claim 13, wherein the image alteration module is configured to alter the magnification of the image by an amount that is proportional with a distance of the motion along the user touch scroll input device.

19. The electronic device of claim 13, wherein the electronic device further comprises a memory device, wherein the image comprises a stored image from the memory device.

20. The electronic device of claim 13, wherein the electronic device further comprises an image capture device having an output, wherein the image comprises an output from the image capture device.
